(19) United States
(12) Patent Application Publication
(10) Pub. No.: US 2009/0066802 A1
(43) Pub. Date: Mar. 12, 2009

(54) IMAGE PROCESSING DEVICE AND METHOD

(76) Inventor: SUGURU ITAGAKI, Tokyo (JP)

Correspondence Address: NEC CORPORATION OF AMERICA, 6535 N. STATE HWY 161, IRVING, TX, 75039, US

(21) Appl. No.: 12/204,030

(22) Filed: Sep. 4, 2008

(30) Foreign Application Priority Data
Sep. 6, 2007 (JP) 2007-231374

(51) Int. Cl. H04N 5/225

(52) U.S. Cl. 348/222.1; 348/E05.024

(57) ABSTRACT

An image processing device according to the present invention comprises an image input unit, a statistical information updater and a background image generator, and generates a background image from an input image. The image input unit sequentially inputs continuous input images. The statistical information updater generates statistical information, which indicates the frequency of occurrence of a statistical quantity in each pixel of the input image, based on the input image from the image input unit. The background image generator generates a background image by selecting in the statistical information a statistical quantity whose frequency of occurrence is the highest for each pixel.

This application is based upon and claims the benefit of priority from Japanese Patent Application No. 2007-231374 filed on Sep. 6, 2007, the content of which is incorporated by reference.

### BACKGROUND OF THE INVENTION

1. Field of the Invention

The present invention relates to a technique for generating a background image from an input image using image processing.

2. Description of the Related Art

There is a technique for detecting an appearing object or a moving object from an input image of video that has been taken by a camera or the like. An approach is known in which a background image is generated from the input image in advance, and the object is detected from the difference between the input image and the background image (see Japanese Patent Laid-Open No. 2007-66124, and Japanese patent Laid-Open No. 9-190533). In such an approach, generation of an appropriate background image can improve the accuracy in detection of an object. However, an object appearing or moving in the input image, or a change in the weather or a change in brightness over time prevents an appropriate background image from being generated.

However, the above described technique has following problems.

The approach disclosed in Japanese Patent Laid-Open No. 2007-66124 calculates a weighted average value and a medium value from the statistical quantities of each pixel, and applies them to the update of the background image. There is the possibility that a vehicle held in a traffic jam or a vehicle stopped at a red traffic light can be captured in the background image.

According to the approach disclosed in Japanese patent Laid-Open No. 9-190533, a brightness value in which the percentage of continuous occurrence is the largest is estimated for the brightness value in the background image. Even in this approach, there is the possibility that a vehicle held in a traffic jam or a vehicle stopped at a red traffic light can be captured in the background image.

### SUMMARY OF THE INVENTION

An exemplary object of the present invention is to provide a technique for reducing the effect on the background image of an object that should not be in a background image.

In order to achieve the above object, an image processing device of an exemplary aspect of the invention that generates a background image from an input image, comprises:

an image input unit that sequentially inputs continuous input images;

a statistical information updater that generates statistical information, which indicates the frequency of occurrence of a statistical quantity in each pixel of the input image, based on the input image from the image input unit; and

a background image generator that generates a background image by selecting, in the statistical information, a statistical quantity whose frequency of occurrence is the highest for each pixel.

An image processing method of an exemplary aspect of the invention that generates a background image from an input image, comprises:

sequentially inputting continuous input images;

generating statistical information, which indicates the frequency of occurrence of a statistical quantity in each pixel of the input image, based on the input image; and

generating a background image by selecting, in the statistical information, a statistical quantity whose frequency of occurrence is the highest for each pixel.

A recording medium of an exemplary aspect of the invention records an image processing program for causing a computer to generate a background image from an input image,

wherein the image processing program causes the computer to:

sequentially input continuous input images;

generate statistical information, which indicates the frequency of occurrence of a statistical quantity in each pixel of the input image, based on the input image; and

generate a background image by selecting, in the statistical information, a statistical quantity whose frequency of occurrence is the highest for each pixel.

The above and other objects, features, and advantages of the present invention will become apparent from the following description with references to the accompanying drawings which illustrate examples of the present invention.

### BRIEF DESCRIPTION OF THE DRAWINGS

FIG. 1 is a block diagram showing the configuration of an image processing device of a first exemplary embodiment;

FIG. 2 is a flowchart showing the operation of the image processing device of the first exemplary embodiment;

FIG. 3 is a diagram illustrating a concrete example of the image processing device of the first exemplary embodiment;

FIG. 4 is a diagram showing an example of an input image;

FIG. 5 is a diagram- showing an example of a background image;

FIG. 6 is a diagram showing an example of a background difference image;

FIG. 7 is a block diagram showing the configuration of an image processing device of a second exemplary embodiment;

FIG. 8 is a diagram illustrating a concrete example of the image processing device of the second exemplary embodiment;

FIG. 9 is a diagram showing an example of a mask image;

FIG. 10 is a diagram showing an example of a masked input image;

FIG. 11 is a diagram showing a masked background image; and

FIG. 12 is a diagram showing an example of the background image in which the update of the portion where a detection target was extracted has been stopped.

### DETAILED DESCRIPTION OF THE PREFERRED EMBODIMENTS

Exemplary embodiments of the present invention will be described in detail with reference to the drawings. Here, an image processing device that generates a background image from an input image, and detects a dynamic object targeted for detection from the difference between the input image and the background image will be described. In order to easily understand the description, a case of detecting, a vehicle moving on the road from an input image of a road that has been taken from a fixed location is illustrated appropriately.

### First Exemplary Embodiment

FIG. 1 is a block diagram showing the configuration of an image processing device of a first exemplary embodiment. Referring to FIG. 1, image processing device 10 includes image input unit 11, statistical information updater 12, background image generator 13 and difference processor 14.

Image input unit 11 inputs continuous input images that have been taken by a camera or the like. The input images from image input unit 11 are sent to statistical information updater 12 and difference processor 14.

Based on the input images from image input unit 11, statistical information updater 12 generates statistical information for the input images, and sequentially updates the statistical information. The statistical information for input images is an aggregate of statistical information for each pixel. The statistical information for each pixel is information indicating the frequency of occurrence (e.g., occurrence count) of each value that a statistical quantity may take when a value shown by a pixel (e.g., brightness value) is the statistical quantity. Information about input images from past to present for a certain period of time is compiled into the statistical information. As a concrete example, if L₁, L₂, . . . , and L_{M} are possible values that can be taken as a brightness value, it is sufficient to include in the statistical information for each pixel, information such as, the occurrence count of the brightness value L₁ is N₁, the occurrence count of the brightness value L₂ is N₂, . . . , the occurrence count of the brightness value L_{M} is N_{M}. In this case, N₁+N₂+ . . . +N_{M} is the number of the input images (frames) for the certain period of time.

It is sufficient to set the certain period of time, for defining the range of the input images to be complied into statistical information, to an appropriate period of time according to the character of the change in the image to be taken. Preferably, it is set to such a period of time that the background image can follow the change in a region that should be in the background image, such as a change in the weather or a change in the brightness of the road over time, and a portion that should not be in the background image, such as a vehicle temporarily stopped at a red traffic light, is not included in the background image.

Background image generator 13 generates a background image from the statistical information of the input image generated by statistical information updater 12. A background image is an image in which, for each pixel, the statistical quantity whose frequency of occurrence is the highest (the most frequent value) is the statistical quantity of the pixel. More specifically, the statistical quantity whose frequency of occurrence is the highest in the pixel is adopted as the brightness value for each pixel of the background image.

Difference processor 14 calculates the difference between the input image from image input unit 11 and the background image generated by background image generator 13. A difference image that is made from this difference is an image showing a detection target in the input image.

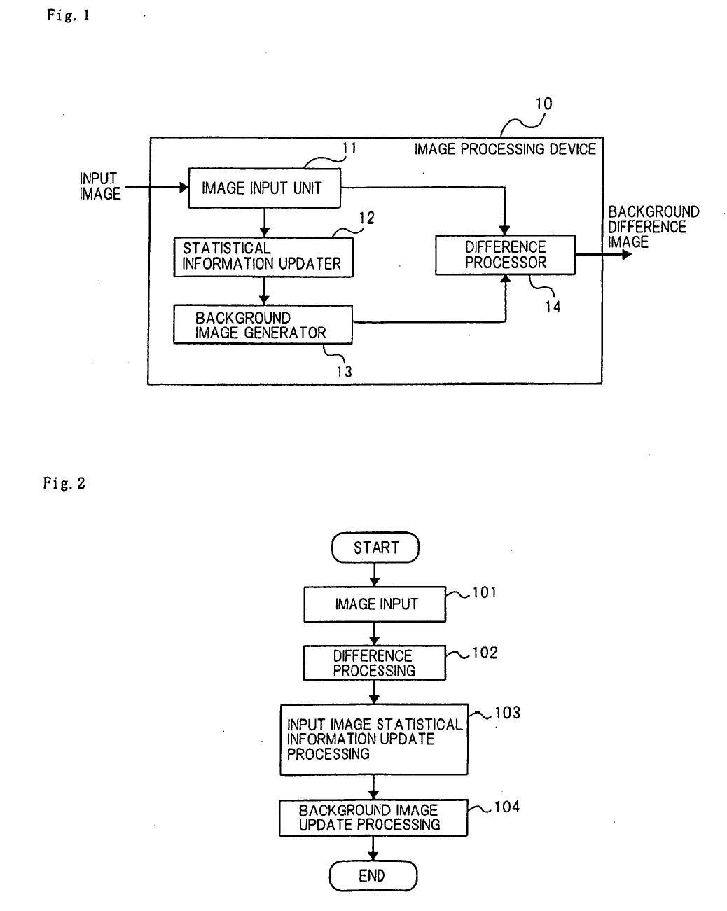

FIG. 2 is a flowchart showing the operation of the image processing device of the first exemplary embodiment. The flowchart shows operation which is performed after a situation in which the background image has already been generated.

Referring to FIG. 2, image processing device 10 inputs a new input image that has been taken by a camera or the like (step 101). Image processing device 10 calculates the difference between the new input image and the pre-generated background image (step 102).

Further, image processing device 10 adds information for the new input image, and deletes information for the oldest input image to update the statistical information for the input image (step 103). Then, image processing device 10 re-generates the background image using the updated statistical information (step 104).

As described above, according to the present exemplary embodiment, for each pixel, the frequency of occurrence of a statistical quantity is the basis for determining the statistical quantity of the pixel, which therefore avoids including in the background image an image whose frequency of occurrence is lower than an image that should be in a background image, and which should not be in the background image. For example, a case is assumed in which, in a certain pixel, when vehicles are stopped at a red traffic light, the time when the brightness value of the specific vehicle continues is extended, on the other hand, when vehicles are moving, the brightness values of a plurality of passing vehicles are narrowed, and the time when the brightness value of the road continues is shortened than it. In the present exemplary embodiment, even in such a case, if the brightness value of the road which occurs repeatedly and is distributed over the entirety of statistical information has the highest frequency of occurrence in total, a background image where no vehicle has been captured can be generated.

Conventionally, when the statistical quantities of the whole input image suddenly changed due to a change in the weather and sunshine, sometimes the background image could not follow the change; however, according to the present exemplary embodiment, statistical information calculated based on input images from past to present for a certain period of time is used, eliminating the effect of an input image that is older than a certain period of time, and improving the follow-up of changes in a portion of an input image that should be in a background image.

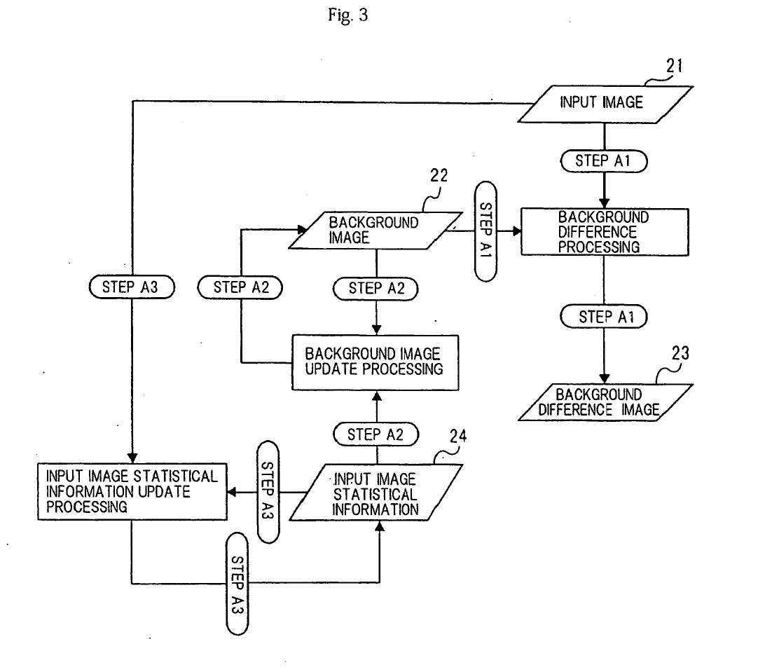

FIG. 3 is a diagram illustrating a concrete example of the image processing device of the first exemplary embodiment. Every time a new input image is inputted, image processing device 10 re-calculates the difference between the input image and the background image, and updates the statistical information for the input information and the background image. It is assumed that input image 21 is a moving image for which a fixed point is taken by a visual camera or an infrared camera. Input image 21 can be data-processed on a frame basis. Every time a new frame of input image 21 is inputted, the difference between the input image and the background image is calculated, and the statistical information for the input information and the background image are updated.

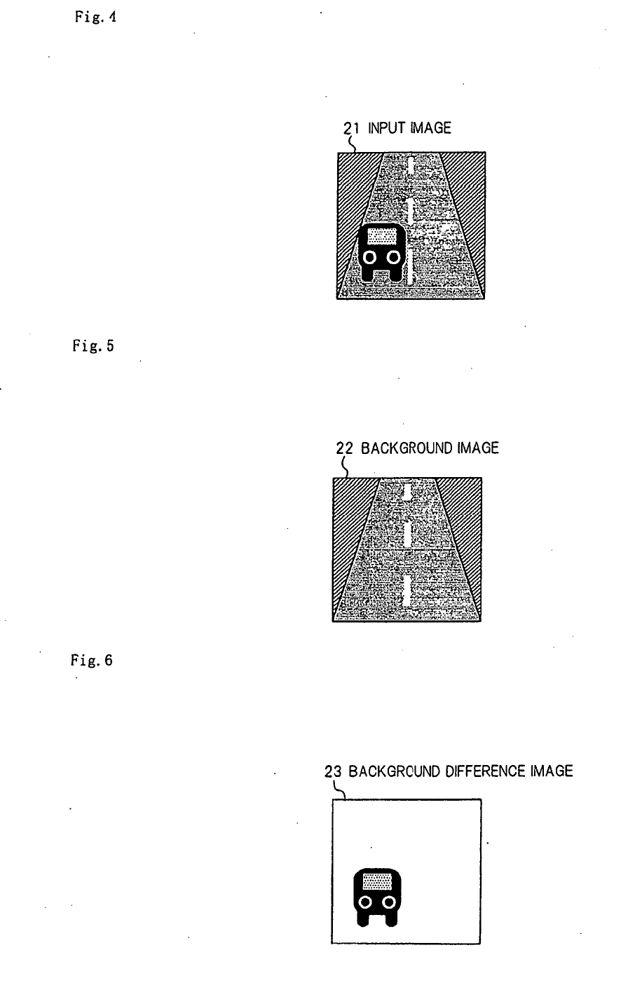

FIG. 4 is a diagram showing an example of an input image. FIG. 5 is a diagram showing an example of a background image. FIG. 6 is a diagram showing an example of a background difference image.

In input image 21 of FIG. 4, an image to be extracted as a background image is an image of a road, and an image to be extracted as a background difference image is an image of a vehicle. In background image 22 of FIG. 5, the vehicle, which is a detection target, is eliminated from input image 21, and the image of the road is shown. In background difference image 23 of FIG. 6, the image of the vehicle is shown as the difference between input image 21 and background image 22.

When input image 21 is inputted, image processing device 10 executes a background difference processing (step A1). Background difference processing is a process in which, in order to extract from an image an object targeted for detection, the difference in statistical quantities between a background image where no object targeted for detection appears and an input image where an object targeted for detection appears is obtained, and an image where only the object targeted for detection appears (background difference image) is generated from this difference. By combining the background difference processing and another image processing, an object targeted for detection can be detected.

In the example of FIG. 3, input image 21 and background image 22 are used for the background difference processing, and, as a result of the background difference processing, background difference image 23 is generated. Background difference image 23 is an image which is generated from input image 21 and background image 22, and where only an object targeted for detection is extracted. However, speaking strictly, noise is included in background difference image 23 in addition to the object targeted for detection.

Input image statistical information 24 is statistical information related to a past input image, required to update background image 22. More specifically, it is information that includes, for each pixel of input image 21, the statistical quantity (brightness value or the like) and occurrence count. Input image statistical information 24 is sequentially updated, and updated input image statistical information 24 is provided for background image update processing.

When input image 21 is inputted, image processing device 10 executes input image statistical information update processing (step A3). The input image statistical information update processing is a process in which new input image 21 is used to update input image statistical information 24.

Input image statistical information 24 is information which makes statistical quantities for each pixel to be updated and the frequency of occurrence compassable in time sequence. As a concrete example, the statistical quantities for each pixel of past input image 21 are kept in the order of the frequency of occurrence. Further, input image statistical information 24 has a configuration in which the statistical quantity of old input image 21 can be deleted. In the input image statistical information update processing, for each pixel to be updated in input image 21, the frequency of occurrence of the statistical quantity is summed, and the statistical quantities are reordered in the descending order of the frequency of occurrence of the statistical quantity, in such a way that the information for new input image 21 is added, and the information of the oldest input image 21 is deleted.

When input image statistical information 24 is updated, image processing device 10 subsequently executes background image update processing (step A2). Background image update processing is a process in which background image 22 is sequentially updated so that a satisfactory background difference image 23 is detected in the background difference processing. In the present exemplary embodiment, a value for which the frequency of occurrence is the highest (the most frequent value) among the statistical quantities of each pixel of input image 21 included in input image statistical information 24 is selected as the post-update value for each pixel of background image 22, and is applied to each pixel of the background image.

Image processing device 10 repeats the process of steps A1 to A3 every time input image 21 is inputted.

### Second Exemplary Embodiment

In the first exemplary embodiment, when there are vehicles stopped due to a traffic accident, and when vehicles are parked for a long time, there is the risk that a vehicle targeted for detection may be induced in a background image. Further, there is a risk that the same may occur when a vehicle stops at a red traffic light and at a traffic jam, depending on the relationship between the time while the vehicle is stopped and the value set for the certain period of time that defines a range of input images to be used for statistical information.

In the second exemplary embodiment, the following three measures are applied to the above problem.

As a first measure, in the second exemplary embodiment, the image of a portion extracted as a detection target is excluded from input image statistical information update processing and background image update processing. More specifically, for pixels included in the portion extracted as a vehicle, the statistical information of the input image and the background image are not updated.

As a second measure, in the second exemplary embodiment, the occurrence of an event in which a dynamic object is held (hereinafter referred to as a holding event) is monitored based on a difference image, and while the holding event is occurring, input image statistical information update processing and background image update processing are halted.

As a third measure, in the second exemplary embodiment, when the event that caused the hold can be learned via information from the outside (hereinafter referred to as holding event information), based on the holding event information, execution and halt of input image statistical information update processing and background image update processing are controlled. More specifically, it is sufficient to use the traffic signal information indicating the display state (green, yellow and red) of the traffic signal as holding event information, and to execute input image statistical information update processing and background image update processing only when the traffic light is green.

Incidentally, in the first measure described above, when an object is held for a long time, a situation is assumed in which the background image of a portion extracted as a detection target is not updated for a long time. Thus, in stead of halting input image statistical information update processing and background image update processing of the portion in which an object was detected, the background image of the portion in which the object was detected may be updated by estimating the background image from the statistical information of a neighboring region in which no object has been detected. More specifically, the brightness value of the road of the portion in which a vehicle was detected may be matched with the brightness value of the neighboring road.

Even in the second and third measures described above, if the holding event continues for a long time, a situation is assumed in which the background image is not updated for a long time. Thus, in stead of halting the input image statistical information update processing and the background image update processing, for a region in which no object has been detected, the normal input image statistical information update processing and background image update processing are continued; for a region in which an object is detected, the background image may be updated by estimating the background image from the statistical information of the neighboring region in which no object has been detected.

Further, in the first exemplary embodiment, input image statistical information update processing and background image update processing are executed on the entire input image. However, depending on the type of detection target and the location of the shooting, an input image sometimes contains a region where it is obvious that no object will appear. In such a case, in the first exemplary embodiment, image processing is executed even on a portion that does not contribute to the detection of an object, which is not efficient.

Thus, in the second exemplary embodiment, a region in which it is obvious that no object will appear is masked, and input image statistical information update processing, background image update processing and background difference processing are not executed on the region.

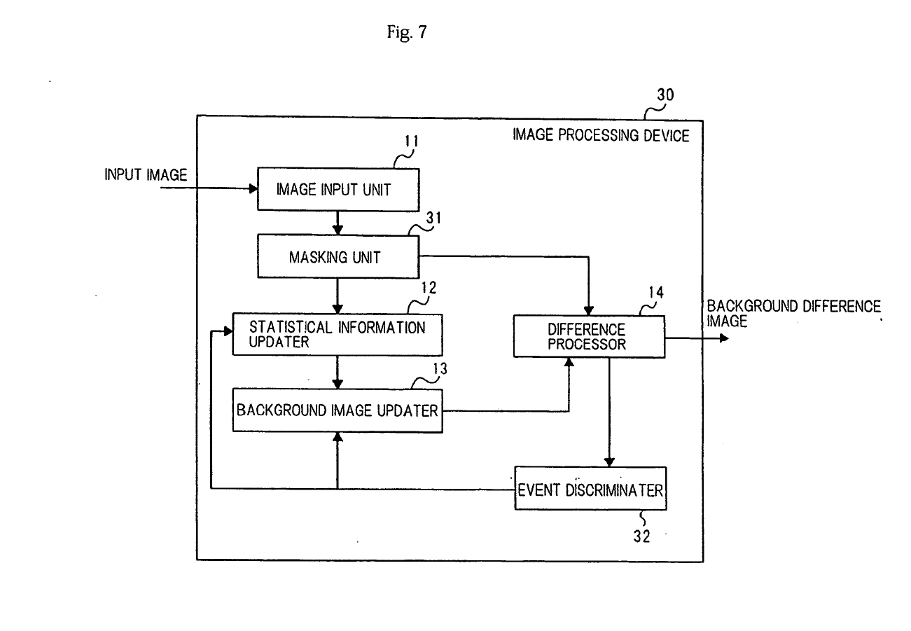

FIG. 7 is a block diagram showing the configuration of an image processing device of a second exemplary embodiment. Referring to FIG. 7, image processing device 30 includes image input unit 11, masking unit 31, statistical information updater 12, background image generator 13, difference processor 14 and event discriminater 32.

Image input unit 11 is the same as that in the first exemplary embodiment shown in FIG. 1. In the present exemplary embodiment, an input image from image input unit 11 is sent to masking unit 31.

Masking unit 31 holds mask information indicating a portion to be masked in the input image in advance, and masks the input image from image input unit 11 using the mask information. The input image masked by masking unit 31 is sent to statistical information updater 12 and difference processor 14.

Statistical information updater 12 generates statistical information on a region that has not been masked in the input image based on the masked input image from the masking unit 31, and sequentially updates it.

However, as the first measure described above, in the present exemplary embodiment, statistical information updater 12 does not execute processing on the image of the portion extracted as a detection target by difference processor 14.

Further, as the second measure described above, in the present exemplary embodiment, statistical information updater 12 halts the processing while a holding event is being detected by event discriminater 32.

Further, as the third measure described above, in the present exemplary embodiment, statistical information updater 12 controls the execution and halt of processing based on the holding event information from the outside. More specifically, statistical information updater 12 executes processing only when the traffic light is green based on the traffic signal information that indicates the display state of the traffic signal.

For a region that is not masked, background image generator 13 generates a background image from the statistical information of the input image generated by statistical information updater 12.

However, as the first measure described above, in the present exemplary embodiment, background image generator 13 does not execute processing on the image of the portion extracted as a detection target by difference processor 14.

Further, as the second measure described above, in the present exemplary embodiment, background image generator 13 halts the processing while a holding event is being detected by event discriminater 32.

Further, as the third measure described above, in the present exemplary embodiment, background image generator 13 controls the execution and halt of the processing based on the holding event information from the outside. More specifically, background image generator 13 executes the processing only when the traffic light is green, based on the traffic signal information.

Difference processor 14 calculates the difference between the masked input image from masking unit 31 and the background image generated by background image generator 13. The image made from the difference becomes a background difference image indicating a detection target in the input image.

Event discriminater 32 monitors the occurrence of a holding event based on the difference calculated by difference processor 14, and notifies statistical information updater 12 and background image updater 13 of the occurrence of the holding event.

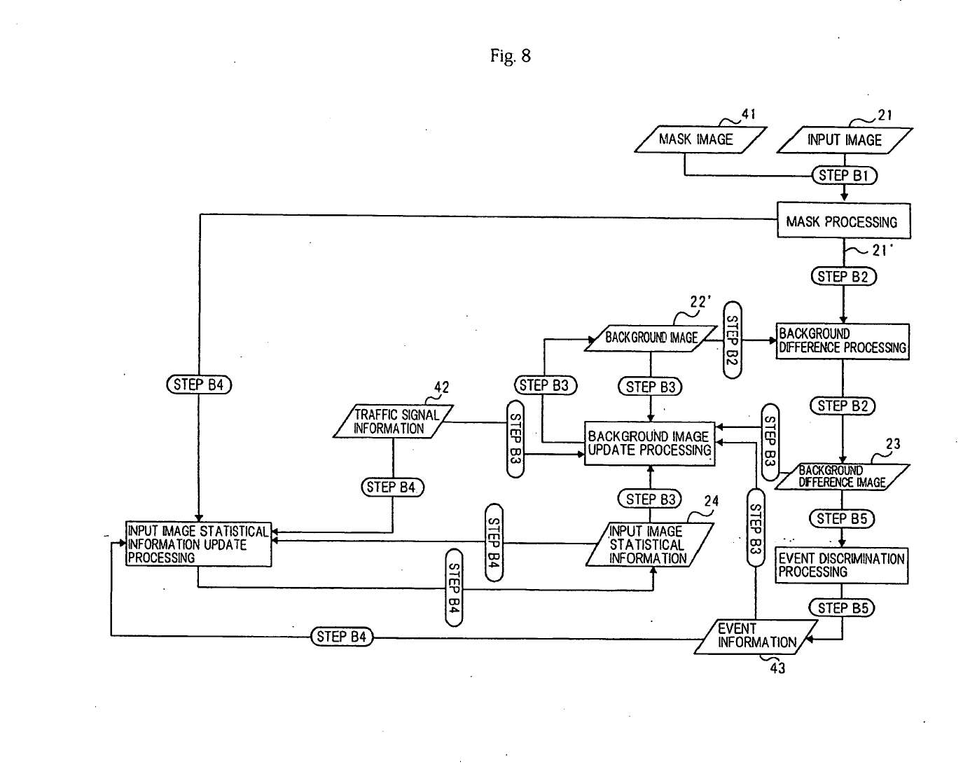

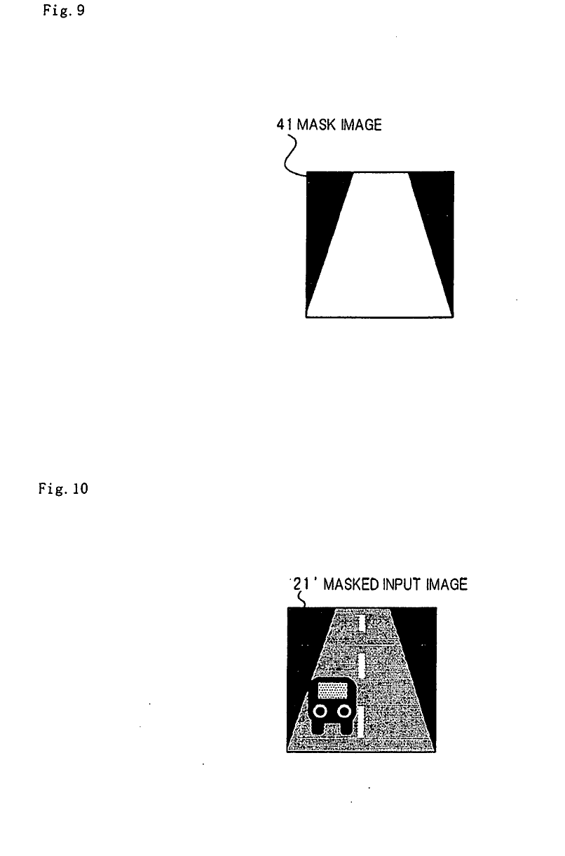

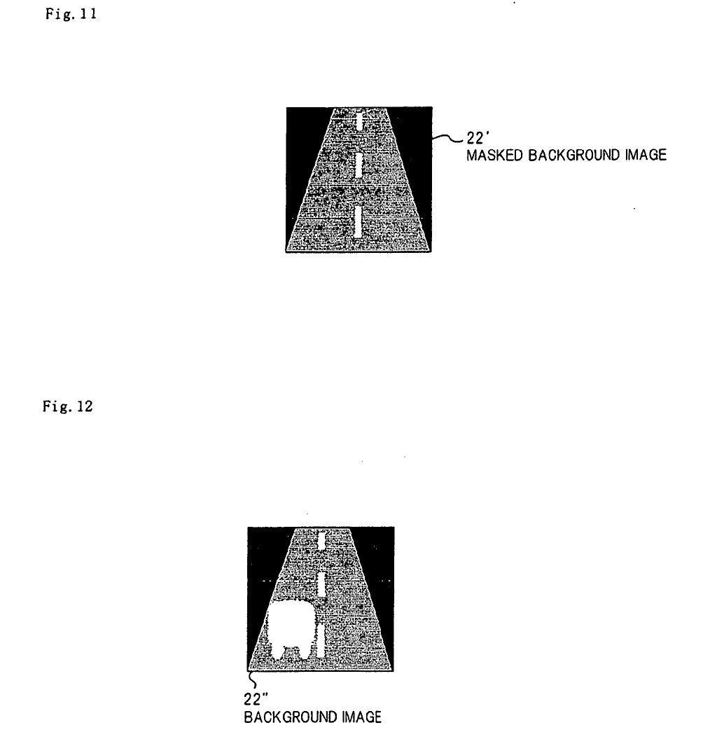

FIG. 8 is a diagram illustrating a concrete example of the image processing device of the second exemplary embodiment. FIG. 9 is a diagram showing an example of a mask image. Since it is not necessary to detect a vehicle from a portion other than a road when trying to detect a vehicle moving on the road, a portion other than the road is masked as shown in FIG. 9. FIG. 10 is a diagram showing an example of a masked input image. FIG. 11 is a diagram showing a masked background image.

When input image 21 is inputted, image processing device 30 uses mask image 41 to mask input image 21 (step B1). Masked input image 21′ is shown in FIG. 10. Further, image processing device 30 uses masked input image 21′ and masked background image 22′ to execute background difference processing (step B2). Moreover, image processing device 30 uses the difference calculated by background difference processing to execute event discrimination processing (step B5). Event discrimination processing is a process in which, based on the difference, the occurrence of an event affecting the update of the background image (e.g., holding event described above) is monitored. The presence or absence of an event is inputted into input image statistical information update processing and background image update processing as event information 43.

Image processing device 30 uses masked input image 21′ to execute input image statistical information update processing (step B4), and then, uses statistical information 24 of the input image resulting from step B4 to execute background image update processing (step B3). In so doing, image processing device 30 controls the execution and halt of input image statistical information update processing and background image update processing based on traffic signal information 42 and event information 43.

Further, in background image update processing, image processing device 30 may estimate, based on background difference image 23, the background image of the portion in which an object was detected from the statistical information of a neighboring region in which no object has been detected before updating the background image. More specifically, the brightness value of the portion of the road in which a vehicle was detected may be matched with the brightness value of the neighboring road.

FIG. 12 is a diagram showing an example of the background image in which the update of the portion where a detection target was extracted has been stopped. In background image 22″ of FIG. 22, due to a change in the weather while a vehicle is stopped, the image of the portion from which the vehicle has been extracted no longer matches the image of a neighboring region. Even in this case, by matching the brightness value of the portion of the road from which the vehicle has been extracted with the brightness value of the neighboring road, the image can be corrected to background image 22″ shown in FIG. 11.

Note that the image processing device of each exemplary embodiment described above can also be achieved by causing a computer to execute a software program that defines the processing procedure of each portion configuring the image processing device.

While preferred exemplary embodiments of the present invention have been described using specific terms, such description is for illustrative purposes only, and it is to be understood that changes and variations may be made without departing from the spirit or scope of the following claims.

What is claimed is:

1. An image processing device that generates a background image from an input image, comprising:
an image input unit that sequentially inputs continuous input images;
a statistical information updater that generates statistical information, which indicates the frequency of occurrence of a statistical quantity in each pixel of the input image, based on the input image from the image input unit; and
a background image generator that generates a background image by selecting in the statistical information a statistical quantity whose frequency of occurrence is the highest for each pixel.

2. The image processing device according to claim 1, wherein the statistical information updater compiles information about input images from past to present for a certain period of time into the statistical information, every time a new input image is inputted, adds information about the new input image to the statistical information, and deletes information about the oldest input image from the statistical information to update the statistical information.

3. The image processing device according to claim 1, further comprising a difference processor that calculates a difference between the input image from the image input unit and the background image generated by the background image generator.

4. The image processing device according to claim 3, wherein at least one or more from among the statistical information updater and the background image generator halts processing on an image of a portion where a detection target was detected as the difference calculated by the difference processor.

5. The image processing device according to claim 1, further comprising
an event discriminater that monitors the occurrence of an event affecting generation of the background image, based on the difference calculated by the difference processor,
wherein at least one or more from among the statistical information updater and the background image generator controls the execution and halt of processing based on a monitoring result by the event discriminater.

6. The image processing device according to claim 1, wherein at least one or more from among the statistical information updater and the background image generator controls the execution and halt of processing based on an event notified from the outside.

7. The image processing device according to claim 5, wherein
the event is a holding event in which a dynamic object is held, and
at least one or more from among the statistical information updater and the background image generator halts processing while the holding event is occurring.

8. The image processing device according to claim 6, wherein
the event is a holding event in which a dynamic object is held, and
at least one or more from among the statistical information updater and the background image generator halts processing while the holding event is occurring.

9. The image processing device according to claim 3, wherein a portion in which a detection target has been detected as the difference calculated by the difference processor is estimated and updated by the background image generator from the statistical information of a neighboring region in which no object has been detected.

10. The image processing device according to claim 1, further comprising a masking unit that masks the input image inputted by the image input unit according to predetermined mask information.

11. An image processing device that generates a background image from an input image, comprising:
image input means for sequentially inputting continuous input images;
statistical information update means for generating statistical information, which indicates the frequency of occurrence of a statistical quantity in each pixel of the input image, based on the input image from the image input means; and
background image generate means for generating a background image by selecting in the statistical information a statistical quantity whose frequency of occurrence is the highest for each pixel.

12. An image processing method that generates a background image from an input image, comprising:
sequentially inputting continuous input images;
generating statistical information, which indicates the frequency of occurrence of a statistical quantity in each pixel of the input image, based on the input image; and
generating a background image by selecting in the statistical information a statistical quantity whose frequency of occurrence is the highest for each pixel.

13. The image processing method according to claim 12, comprising: compiling information about input images from past to present for a certain period of time into the statistical information, every time a new input image is inputted, adding information for the new input image to the statistical information, and deleting information for the oldest input image from the statistical information to update the statistical information.

14. The image processing method according to claim 12, further comprising: calculating a difference between the input image and the generated background image.

15. A recording medium that records an image processing program to causes a computer to generate a background image from an input image,
wherein the image processing program causes the computer to:
sequentially input continuous input images;
generate statistical information, which indicates the frequency of occurrence of a statistical quantity in each pixel of the input image, based on the input image; and
generate a background image by selecting in the statistical information a statistical quantity whose frequency of occurrence is the highest for each pixel.

16. The recording medium according to claim 15, wherein information about input images from past to present for a certain period of time is compiled into the statistical information, every time a new input image is inputted, information for the new input image is added to the statistical information, and information for the oldest input image is deleted from the statistical information to update the statistical information.

17. The recording medium according to claim 15, wherein the image processing program further causes a computer to calculate a difference between the input image and the generated background image.
